(19) United States
(12) Patent Application Publication
(10) Pub. No.: US 2019/0266534 A1
(43) Pub. Date: Aug. 29, 2019

(54) MULTI-CRITERIA ADAPTIVE SCHEDULING METHOD FOR A MARKET-ORIENTED HYBRID CLOUD INFRASTRUCTURE

(71) Applicant: Worldline, Bezons (FR)

(72) Inventor: Yacine KESSACI, Lille (FR)

(21) Appl. No.: 16/318,918

(22) PCT Filed: Jul. 20, 2016
(86) PCT No.: PCT/IB2016/001186

§ 371 Date: Jan. 18, 2019

(51) Int. Cl. G06Q 10/06; G06F 9/455; G06F 9/50; G06N 3/12

(52) U.S. Cl. CPC G06Q 10/06315; G06F 9/45558; G06F 2009/4557; G06N 3/126; G06F 2009/45595; G06F 9/5077

(57) ABSTRACT

Some embodiments are directed to a computing scheduler for a market-oriented hybrid cloud infrastructure composed of private and public machines and wherein services specified in a contract, comprising the steps of: predicting the workload of requests of services, sampling the service workload by dividing the day into slots of a finished period of time, the period of a slot being a parameter; deducting a pool of virtual machines (VMs) from the sampled service workload for a day; assigning the service requests to the pool of VMs according to each slot of the day; initializing, for a slot k, a population of VMs assignments; applying a genetic algorithm to compute the solutions of VMs scheduling for each slot; storing the solutions in a Pareto archive; selecting a solution according to a chosen policy; saving the current state; repeating the operations until all the slots of a day have been processed.

### CROSS REFERENCE TO RELATED APPLICATION(S)

This application is a National Phase Filing under 35 C.F.R. § 371 of and claims priority to PCT Patent Application No. PCT/IB2016/001186, filed on Jul. 20, 2016, the content of which is hereby incorporated in its entirety by reference.

### BACKGROUND

The invention relates to a computing scheduling method for a market-oriented hybrid cloud infrastructure containing public and private machines, with the goal of reducing the cost of the cloud usage while respecting the conditions of the service contract during the execution.

The performance and the profit of a company depend on several parameters. One major parameter for Information Technology (IT) companies is the efficiency of the infrastructure that they use to provide their services. Therefore, the objective for an IT company is to find the optimum balance between the quality of the services that it provides, specified by the Service Level Agreement (SLA), and the reduction of the costs induced by these services.

Several researches have been carried out to develop new methods in that sense. The orientations of such researches are either toward the load prediction or the resource scheduling optimization purposes.

Cloud computing is a computer science paradigm that brings several evolutions to distributed computing. Hence, applications, data and infrastructures are proposed as services that can be consumed in a ubiquitous, flexible and transparent way. However, the flexibility in the cloud usage is made at the price of some requirements on accessibility, performance and security as explained in S. Bouchenak (2013), Verifying cloud services: Present and future.

This is due to the distribution, heterogeneity and concurrent usage of the cloud environment. As an example, the companies proposing web-based application services are particularly subject to this phenomenon. Indeed, since major of such services are accessed from a web browser, all the users' needs are spread over millions of small requests.

The main issue with such kind of workloads is their fine-grained nature which let the resource needs difficult to predict. Therefore, it requires specific prediction techniques with more accuracy and additional features that help to compensate the lack of information in comparison with those available in batch workload prediction.

Furthermore, a recent study J. Koomey (2011), Growth in data center electricity use 2005 to 2010, shows that data center electricity increased by 265% from 2000 to 2010, while worldwide electricity increased by 41%. Moreover, according to an Amazon's estimate J. Hamilton (2009), Cooperative expendable micro-slice servers (CEMS): Low cost, low power servers for internet-scale services, the energy-related costs amount represents 42% of the total data center budget, and includes both direct power consumption 19% and cooling infrastructure 23%, these values are normalized with a 15 years amortization.

It appears that energy is one of the many important and challenging issue to deal with. Therefore, it clearly appears that predicting the correct amount of needed resources helps reducing the number of turned-on data centers, minimizing the energy consumption. Indeed, over-provisioning wastes resources that could be turned-off or dedicated to another usage, while under-provisioning resources in a market oriented cloud environment causes Service Level Objective (SLO) misses. This generates Service Level Agreement (SLA) violations, which usually induces significant financial penalties.

Thus, the global hosting cost is not only related to energy but also to the SLA and other parameters such as the infrastructure price and its amortization. Moreover, the SLA criterion as addressed in different cloud environment in J. Chen (2011), Tradeoffs between profit and customer satisfaction for service provisioning in the cloud and in E. Elmroth (2009), Accounting and billing for federated cloud infrastructures, uses performance and SLA models that do not fit the market cloud features presented in S. Bouchenak (2013), Verifying cloud services: present and future.

The objective of some embodiments are therefore to cope with these lacks by proposing a two-level approach dealing with the optimization of the hosting costs over a cloud-oriented fuzzy SLA model in a hybrid cloud environment.

The specification of the problem is the optimization of the resource management of a SaaS cloud infrastructure of a web-service company. There were identified ten largest proposed services of such a company, each service belonging to a family type of services (e.g. merchant, e-transactional . . . ). The features of all these kinds of services are their web remote access.

Therefore, some embodiments propose a two-level approach with a first level based on a statistical history method for service workload prediction and a second level based on a scheduling method for the assignment of the needed resources for the services' prediction over the cloud infrastructure. The role of the first level is to extract, by analyzing the requests, all the information that may be necessary to accurately estimate the size and the number of Virtual Machines (VMs) dedicated for each service at each time slot of the day.

Besides, the role of the second level is to make from this pool of VMs the best or better assignment over a hybrid cloud. The hybrid cloud is composed of private data centers owned by the company and public data centers owned by external cloud provider.

None of the existing approaches proposes a two level approach combining prediction and scheduling to cope with the SLA and the hosting cost objectives. Besides, none of the existing SLA works addresses the SLA criterion following a cloud-oriented model. Some embodiments propose new approaches that tackle these lacks for a web-service company use case within a hybrid cloud.

The proposed prediction level is based on the statistical study of the archived workload histories of the previous years for each day. Regarding the scheduler, it is based on a Pareto multi-objective genetic algorithm that provides a scheduling by dispatching the predicted virtual machines (VMs) according to the best or better tradeoff between the hosting cost and the SLA satisfaction.

The main contributions of some embodiments are:
a statistical daily-slot-history method for service VM prediction,
a hosting cost SLA aware Pareto multi-objective scheduler for web service VM assignment,
new SLA and cost evaluation models for VM assignments.

### SUMMARY

Some embodiments of the presently disclosed subject matter are directed to a new approach called P-GAS (Prediction-based Genetic Algorithm Scheduler) with the particularity of combining both prediction and scheduling using two steps. The first step aims at predicting the daily request load variation for each provided service and determining its associated resource needs (VMs). The role of the second step is to optimize (in a Pareto way) the assignment of these VMs. The objective is to find the best or better tradeoff between the reduction of the hosting costs and the preservation of the SLA.

Some embodiments of the presently disclosed subject matter propose a computing scheduling method for a market-oriented hybrid cloud infrastructure composed of private and public machines and characterized by services specified in a contract, including the steps of:
transforming a continuous flow of requests into batches,
predicting a pool of virtual machines (VMs) assigned to several services, for a day, including the operations of:
   taking into account the history data of at least one year before the studied day, wherein each day is identified by its date and its status such as business day, weekend, special period or holidays, the history data containing the workload behavior of each service for each day,
   retrieving the history data of at least one day of the year(s), characterized by the same information status and calendar date,
   retrieving the workload behavior of each service for the day, based on the retrieved history data of the day before the studied day, and defining assignments of a finished number of VMs for each service workload, each VM n being defined by a tuple (sizeₙ,nbₙ,fₙ,mₙ,ioₙ,bwₙ,sₙ) wherein sizeₙ is the size of the VM, nbₙ is its number of cores, fₙ is the processor frequency, mₙ is the memory capacity, ioₙ is its input and output capacity, bwₙ is its network bandwidth capacity, sₙ its storage capacity, and each service being identified by a triplet (rqᵢ,vmᵢ,natureᵢ), wherein rqᵢ is the total number of requests per day, vmᵢ is the type and size of needed VMs, and natureᵢ is the nature of the service,
   sampling the service workload by dividing the day into slots of a finished period of time, the duration period of a slot being a parameter,
predicting the number of requests Nb_request_{k,i} for each service i in a slot k, using time series methods over the matching days history,
generating, from the history statistics, a distribution law of each service i for a specific day,
computing the density of requests Density_Coef_{k,i} that each service i is expected to deal with during the slot k applying the formula Density_Coef_{k,i}=Max_Nb_requestᵢ/Nb_request_{k,i} wherein Max_Nb_requestᵢ is the maximum number of requests that a service can receive during the day for a slot, and corresponds to the highest value of the expected distribution law generated from the history statistics of a service i for a specific day,
retrieving from the service workload predictions (Density_Coef_{k,i}, Nb_request_{k,i}), the number of VMs for a slot of the day as follows:
   computing the number of needed VMs Number_VMs_{k,i} for each service i at each slot k, applying the formula

$${Number\_VMs}_{k , i} = \frac{{Nb\_request}_{k , i}}{Max\_req {\_Process}_{i} Nb\_Cores {Density\_coef}_{k , i}}$$

wherein Max_req_Processᵢ is the maximum number of requests that one core of the VM type of the service i can process, and Nb_Coresᵢ is the number of cores of the VM type of the service i,
computing the time duration of each service as the period between the first slot and the last slot that contains a number of requests greater than a fixed query threshold value,
initializing, for a slot k, a population of VMs assignments, further including the steps of:
   retrieving the machine type of a VM and assigning it in a new scheduling process to the same machine type if the concerned VM in the currently scheduled slot is already running from a previous one,
   otherwise initializing the VMs assignment by alternating the three following processes: a random initialization of the VMs to any machine type, initializing all the VMs to the low cost private machine type, initializing all the VMs to the public machine type with the highest performance in terms of computation (CPU) and memory (RAM),
applying a genetic algorithm returning several solutions of assignments of VMs over the different machine types composing the hybrid cloud infrastructure, these solutions being stored in the same format as a table of cells wherein each index of a cell represents the identifier of a VM and the value of a cell is the identification number of a machine type,
storing this set of solutions in a Pareto archive,
choosing one solution from the Pareto archive according to a chosen policy,
saving the chosen solution as the new state of the hybrid cloud,
repeating the steps from the VM prediction retrieving of a slot for the following slots until all the slots of the studied day are processed.

The maximum number of requests Max_Nb_requestᵢ for each service i is deducted from the distribution law of both the current processed day and the adequate service, by extracting the maximum number of requests that a service i can receive during the day for a certain slot. According to an advantageous or preferred embodiment, the query threshold value is equal to the number of queries that requires more than the minimum number of standby VMs for each service. The advantageous or preferred setting duration of a slot is fifteen minutes.

The applied genetic algorithm at each slot cycle can be of type NSGA-II characterized in which:
it uses the population provided by the initialization process,
it uses both a swap and shift mutation process,
it uses a two-point crossover operation to generate two solutions s′₁ and s′₂ from two parent solutions s₁ and s₂,
it uses a tournament selection strategy including the operations of:
   randomly selecting two solutions, either from the Pareto archive, the population or both of them,
   selecting individuals according to their non-dominance ranking,
   ranking the individuals according to their crowding distance, the crowding distance being the value of the circumference of the rectangle defined by the left and the right neighbors of the solution or by its unique side neighbor and the infinity in case of a single neighbor,
the population size is one hundred,
the number of generations is five hundred,
the crossover rate is one,
the mutation rate is 0.35,
the fitness of each scheduling solution is computed using the hosting cost and the service level agreement (SLA) value (satisfaction level) of the addressed services, wherein:
   the SLA value of the addressed services is the sum of all the SLA values of the hosted services, where the SLA value of a service is calculated with the formula Current_SLAᵢ−(Slot_Percent_Valueᵢ Penalty_Checkᵢ) where Slot_Percent_Valueᵢ is the fixed percent value of SLA decrease for each slot time of SLA non-compliance, Penalty_Checkᵢ being computed with the steps of:
      initializing its value with the formula Penalty_Checkᵢ=Current_Performanceᵢ−(Performance_Thresholdᵢ(1−Fuzziness_Parameterᵢ)), where Current_Performanceᵢ is the current performance value returned by the sensors, Performance_Thresholdᵢ is the threshold value below which the service is not SLA compliant, Fuzziness_Parameterᵢ is the parameter that defines the flexibility rate of the performance evaluation,
      assigning the value zero to Penalty_Checkᵢ if Penalty_Checkᵢ≥0 then Penalty_Checkᵢ=0, one otherwise,
   the hosting cost is the sum of all the services' hosting costs, wherein the hosting cost of a service i is calculated with the formula Hosting_Costᵢ=Σ_{N}((VM_Cost_per_hₙ durationᵢ)+Penalty_Costᵢ), where Hosting _Costᵢ is the hosting cost estimation for a service at a given moment in a day, VM_Cost_per_hₙ is the VM cost for one hour operation, durationᵢ is the remaining expected service time duration at a given moment in the day, Penalty_Costᵢ is the penalty cost that the provider has to pay in addition to the operating expenditures while hosting the service i and N represents the number of needed VMs to run the service properly, the Penalty_Costᵢ of a service i being computed with the steps of:
      retrieving the new current SLA service value Current_SLAᵢ
      computing the difference Delta_SLAᵢ between the current SLA value Current_SLAᵢ and the minimum SLA value of the addressed service Minimum_SLAᵢ
      assigning zero to Delta_SLAᵢ if Delta_SLAᵢ≥0, or its absolute value otherwise,
      finally computing the Penalty_Costᵢ as the product of Delta_SLAᵢ and Unitary_Penaltyᵢ, where Unitary_Penaltyᵢ is the unitary penalty cost for each decrease of the SLA of the service.

The assignment of VMs to services is done simultaneously minimizing the sum of hosting costs of the services and maximizing the sum of current service SLA values and according to the following constraints:
each VM of a service i can be assigned to only one type of machine,
there is a limited number of machines in the private cloud,
each VM of a service i is assigned to a private machine only after verifying the available capacity, otherwise the VM is assigned to a public machine.

The selection process can be done by a user by selecting manually the most appropriate solution in the Pareto archive according to its current needs.

The selection policy includes the steps of:
selecting the solution that offers the minimum SLA-compliant value with the lowest hosting cost,
choosing the solution with the highest SLA value regardless the hosting cost criterion, if dealing with only non-compliant SLA solutions.

Some embodiments will be better understood and other details, features and advantages of some embodiments will appear reading the following description given with no limiting examples with reference to the accompanying drawings.

### BRIEF DESCRIPTION OF THE DRAWINGS

FIG. 1 is an overall view of the prediction and scheduling based optimization model in a hybrid cloud infrastructure.

FIG. 2 is an illustration of an example of the evolution of a web-service daily request workload of ten different services.

FIG. 3 is an illustration of the problem encoding.

FIG. 4 is a functional diagram of the flowchart of the P-GAS scheduling process.

FIG. 5 is an illustration of the used selection policy for the solution choice in the Pareto archive.

### DETAILED DESCRIPTION OF EXEMPLARY EMBODIMENTS

Before explaining the computing scheduling method, we first explain the investigated problem and describe its models. The system model, used by some embodiments is based on a Software as a Service (SaaS) cloud model, addressing the needs of web-service companies. Some embodiments deals with a three-tier client-provider architecture model, where the web-service company's clients propose services to their end users. The end users have a direct access to the web services through web requests. Each service hosted by the cloud provider (web-service company) in the present approach is proper to a certain client and requires physical resources to be run properly.

The role of this approach is to help the provider to optimize the usage of the dedicated resources for each hosted service while keeping the client's SLA satisfied.

The cloud considered in the system model is a combination of private and public resources. Indeed, dealing with a hybrid cloud, it is composed with the private data center resources of the company but can include temporary external resources from external cloud providers.

In such an environment, the goal of some embodiments is first to predict the request workloads of the end users to have the best or better resource provisioning (VMs). Secondly, the objective is finding the best or better assignment of the predicted VMs on the hosts which compose the hybrid cloud. Therefore, depending on the needs and the request workloads, the resources can be either locally hosted in the private cloud or externally hosted in a public cloud provider.

For the prediction purposes, it is proposed a statistical approach based on the previous daily workload histories of each service to predict its future behaviors.

Regarding the scheduling, it is proposed a multi-objective genetic algorithm. The target of the scheduler is to reduce the number of migrated VMs while striving to optimize simultaneously both VMs' hosting cost and the SLA.

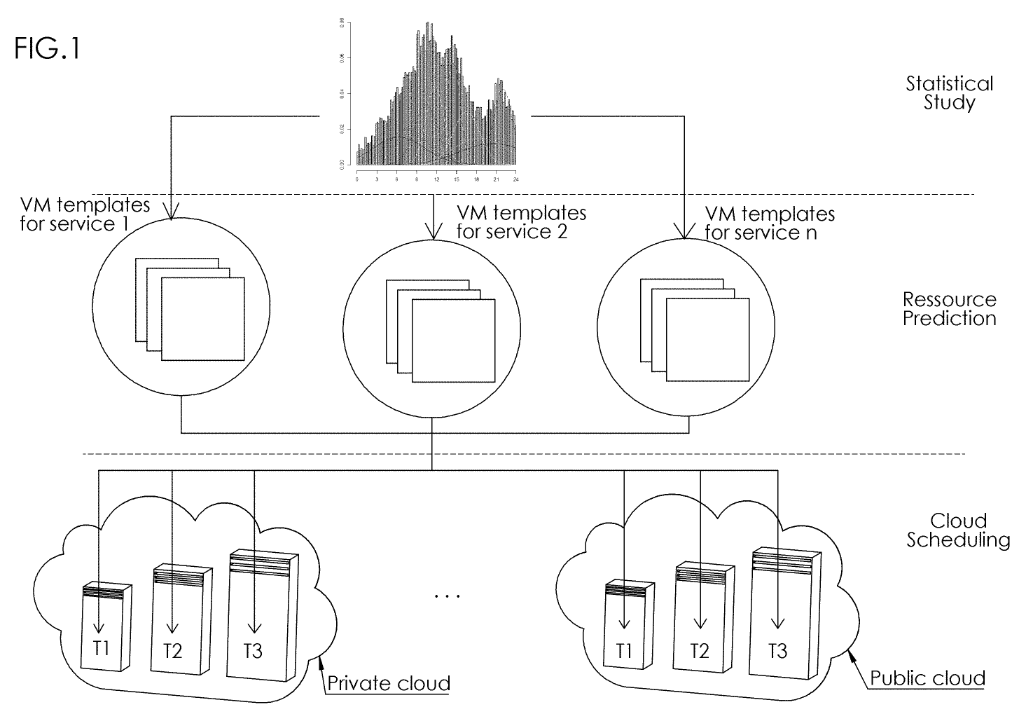

FIG. 1 shows the different levels that compose the proposed optimization process model over the hybrid cloud infrastructure. The optimization of the VMs' hosting cost and the SLA is due to the diversity offered by the heterogeneity of the hosts that compose the hybrid cloud. Indeed, web-service companies or other cloud infrastructure providers are composed of different types of machines. This heterogeneity means different CPU, memory and storage capacities. It also means different running costs and different performances. This offers multiple assignment possibilities helping to achieve the optimization objectives.

To run a viable cloud infrastructure and be competitive regarding the client charged prices, each cloud service provider needs to optimize the usage of its infrastructure. Indeed, reducing the hosting costs is a full part of the cloud economic model. However, reducing the costs has to be done carefully in order to avoid creating drawbacks regarding performance and the competitiveness.

Besides, the performance is set between the client and the cloud provider through Operational-Level Agreements (OLA). Put together, OLA(s) constitute the Service Level Agreement (SLA). It is proposed, in some embodiments, a SLA model that fits the flexible nature of the cloud infrastructure.

Thus, for each service the OLA(s) are composed of: the service performance threshold (availability and response time of the service), the minimum service level value, the unitary penalty cost for each decrease of the SLA under the minimum service level value and the fuzziness SLA parameter.

The service performance threshold is a technical metric that helps to evaluate the service performance. It usually relies on sensors that periodically (one to five minutes) evaluate the reactivity of the service through requests that simulates web requests going through all the three-tier architecture layers (front, middle, back). The resulting value must or should be better than the threshold to consider the SLA compliant; otherwise it decreases the initial service availability value.

The minimum service level value represents a metric that provides information about the percentage of the service availability based on the performance threshold OLA. This value is constantly compared to the current SLA value. The current SLA value is given for each service by initializing it to 100% at the beginning of each month. Each failure of the service decreases the value of the current SLA value. The service is deemed to be none SLA-compliant only when the current SLA value reaches the minimum service level value.

The penalty cost is a unitary value payable by the cloud provider to the client for each decrease under the minimum service level value. The penalty cost is proper to each service's formula itself related to the SLA compliance value. It can follow either a linear or an exponential growth and be bounded or not. In the present approach, it follows a linear increase and represents the value to be paid for each 1% under the minimum service level value.

The fuzziness SLA parameter is proper to the cloud paradigm. It helps to extend the flexibility concept from the infrastructure to the SLA. Indeed, offering on demand services generates more issues regarding their accessibility, reliability and security. Therefore, in order to be in adequacy with the cloud performance variation, the fuzziness concept brings flexibility to the evaluation of performance in return of more advantageous prices for the client. Thus, a service with a fuzziness rate of 0.2 will allow a maximum difference of 20% in the performance threshold before triggering the sanction. This helps to deal with a smarter and less stringent model that suits both the provider and the customer.

Equations (1), (2) and (3) show the steps to compute the total penalty cost of a service:

Penalty_Checkᵢ=Current_Performanceᵢ−(Performance_Thresholdᵢ(1−Fuzziness_Parameterᵢ)) (1)

if Penalty_Checkᵢ≥0 then Penalty_Checkᵢ=0; else Penalty_Checkᵢ=1;

Current_SLAᵢ=Current_SLAᵢ−(Slot_Percent_ValueᵢPenalty_Checkᵢ) (2)

Delta_SLAᵢ=Current_SLAᵢ−Minimum_SLAᵢ;

if Delta_SLAᵢ≥0 then Delta_SLAᵢ=0; else Delta_SLAᵢ=|Delta_SLAᵢ|;

Penalty_Costᵢ=Delta_SLAᵢUnitary_Penaltyᵢ (3)

where index i represents the concerned service, Penalty_Checkᵢ is the value of the current performance of the service, Current_Performanceᵢ is the current performance value returned by the sensors, Performance_Thresholdᵢ is the threshold value below which the service is not SLA compliant, Fuzziness_Parameterᵢ is the parameter that defines the flexibility rate of the performance evaluation, Current_SLAᵢ is the current SLA service value, Slot_Percent_Valueᵢ is the fixed percent value of SLA decrease for each slot time of SLA non-compliance, Minimum_SLAᵢ is the minimum SLA value before triggering the penalty cost, Delta_SLAᵢ is the difference between the current SLA value and the minimum SLA value of the addressed service, Penalty_Costᵢ is the total penalty cost that the provider must or should pay to the client and Unitary_Penaltyᵢ is the unitary penalty cost for each service.

Operating a cloud infrastructure is subject to various expenses. One can count two major: the occasional and the daily expenses. Among the occasional expenses one mentions the ones related to the purchase of the infrastructure. Indeed, owning a cloud needs spending to buy the hardware devices composing the infrastructure and to deal with the warehouse expenses. Besides, the daily expenses are dedicated for operating and maintaining the resources, and paying the energetic expenses of the auxiliary equipment such as lighting and cooling.

Therefore, in the proposed cloud model, all the aforementioned expenses are integrated in order to have a global exploitation cost of each type of machine. Hence, the cost of each type of the private machines is composed of its purchase price and its operating price. The purchase price value is proportional to the amortization of the machine (machine age), when the operating price is composed of the global energetic consumption fees of the machine.

According to an advantageous or preferred embodiment, three main machine types compose the private cloud. Depending on their age and performance, one distinguishes: old machines with low performance with an age older than three years, average machines with middle performance aged less than two years and finally new machines with high performance and less one year of age.

Furthermore it is chosen an external provider for the public part of the hybrid cloud. In this public part, there are three machine instances (4× Large, 8× Large, 10× Large) which have respectively twice the performance of the private cloud machines. The pricing of the instances is based on a scaling proposed by the provider.

Besides, it is deduced the hosting cost of each used VM type, for one hour duration, depending on the hoisting capacity, the performance and the cost of the different types of machines that compose the hybrid cloud.

The present approach is designed to be as seamless as possible to fit the entire hybrid cloud configuration regardless the physical infrastructure features. It aims to benefit from the architecture heterogeneity offered by the different providers and their related machine types to achieve the goal.

Therefore, the predictive part of the present approach depends only on the end users' requests and the types of used VMs while the scheduler handles a high-level scheduling using normalized metrics such as the hosting cost and the performance value to perform the scheduling. Both levels of the present approach use metrics that are weak-coupled with the hardware infrastructure.

In a commercial environment context, one needs to add the operating expenditures, the cloud penalty fees of the non-compliance SLA. Indeed, a non-compliance SLA event gives result to cost penalties. Equation (4) shows how to calculate the total hosting cost of a service.

Hosting_Costᵢ=Σ_{N}((VM_Cost_per_hₙ durationᵢ)+Penalty_Costᵢ) (4)

Where Hosting_Costᵢ represents the hosting cost estimation for a service at a given moment in a day, VM_Cost_per_hₙ is the VM cost for one hour operation, durationᵢ is the remaining expected service time duration at a given moment in the day, Penalty_Costᵢ is the penalty cost that the provider has to pay in addition to the operating expenditures while hosting the service i and N represents the number of needed VMs to run the service properly.

The usage in Equation (4) of parameters to define the characteristics of each service (time duration, list of VMs that may be necessary), is made possible thanks to the prediction step of the present approach. Indeed, this allows having a longer term service behavior view which provides action levers in order to optimize efficiently.

The prediction level of the proposed computing method responds to two main issues. The first issue is the necessity of reducing the number of requisitioned VMs during long idle periods by making their booking fitting as tightly as possible the workload. This helps to reduce the size of the IT infrastructure and therefore the hosting costs. The second issue is to extract information from web request workloads in order to feed the scheduling algorithm with metrics that will make it able to optimize the VMs assignments.

The prediction is based on both refining the granularity (switching from a global workload to a unitary service workload) view and sampling the global web-service workload. It is known that a workload is composed by requests. In the case of a web-service company, these requests belong to different services. Therefore, the approach benefits from this lower granularity by having information about each service individually in order to improve the resource usage. Knowing each service allows using the appropriate type of VM for each one which avoids using generic VM types that might be over-sized.

Besides, sampling the workload into slots gives temporary workload estimation in order to anticipate the amount of needed resources. However, the sampling step needs to be neither fine nor coarse. Fine sampling reduces the prediction accuracy because of big variation of the workload in short periods. Conversely, coarse sampling prevents from having an accurate view of the workload evolution. According to an advantageous or preferred embodiment, a day is sampled into fifteen minutes duration slots. Therefore, sampling allows switching from a continuous request workload to a sort of batch processing. Indeed, by knowing the type of services and the number of requests, one can extract features. The number and type of VMs can be obtained. The type of a VM is based on features such as CPU, memory size, storage capacity, type of the operating system, etc.

Moreover, knowing the service helps to anticipate its duration from the history which may be necessary to estimate the hosting cost. Thus, one can apply a batch model for scheduling the VMs by replacing each batch by a workload time slot.

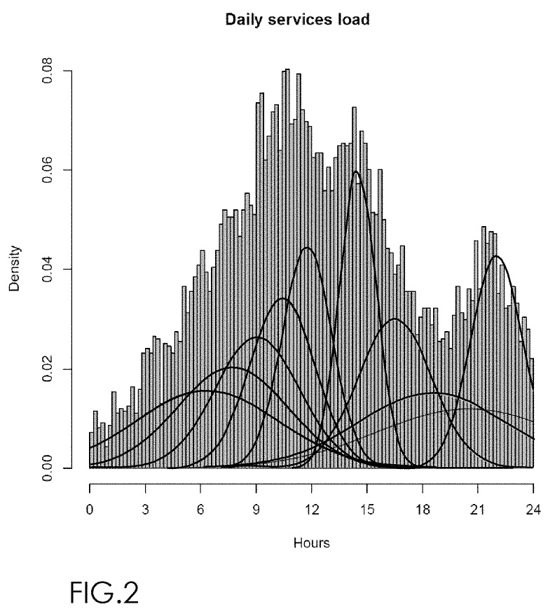

FIG. 2 shows an example of a multi-modal shape of a daily workload requests composed of ten services and sampled into fifteen minutes slots. Each service is represented by a Gaussian distribution representing the increase, the peak and the decrease phases of its workload. It is noticed that the addition of the different services produces the multi-modal shape with three peaks (12 h,14 h,21 h).

In the model of some embodiments, there are three parties: the end users, the clients (services) and the cloud provider (the company). Indeed, end users ask for services which are proposed by clients while the clients host their services on a cloud provider.

Therefore, the scheduling step deals with the clients and the cloud provider. According to an example of application of some embodiments, the cloud provider disposes of a hybrid architecture owning Mₚᵣᵢᵥₐₜₑ machines of three different types (old, average, new) and renting M_{public} machines of three other different types (for example 4× Large, 8× Large, 10× Large). It is assumed that the number of private machines Mₚᵣᵢᵥₐₜₑ is limited when the number of rented ones M_{public} can be extendible.

At each time slot of a day, the scheduler deals with N VMs from different services to answer the end users' requests. The problem includes or consists in scheduling N VMs on M machines of six different types.

It is known that the task scheduling problem is non-deterministic polynomial-time hard (NP-hard, see M. R. Garey (1979) Computers and Intractability: A Guide to the Theory of NP-Completeness). Therefore, the VMs scheduling problem is NP-hard as well. Thus, a metaheuristic algorithm appears to be the most appropriate approach to solve the problem. Thus, in some embodiments an evolutionary approach with a multi-objective genetic algorithm is proposed.

During the process, the scheduler needs information about VMs n,n+1,n+2, . . . and services i,i+1,i+2, . . . According to some embodiments, a VM n is modeled by the tuple (sizeₙ,nbₙ,fₙ,mₙ,ioₙ,bwₙ,sₙ) and the service i by the triplet (rqᵢ,vmᵢ,natureᵢ). All the information is retrieved from the prediction level as aforementioned. The VMs features represent respectively: the size of the VM (sizeₙ), the number of cores (nbₙ), the processor frequency (fₙ), the memory capacity (mₙ), input and output capacity (ioₙ), network bandwidth capacity (bwₙ), the storage capacity (sₙ). The service features represent the total number of requests per day (rqᵢ), the type and size of needed VMs (vmᵢ) and the nature of the service (natureᵢ) which is determined by its topology (computational complexity).

The first objective function of the present approach is to minimize the hosting costs of the entire infrastructure when assigning the VMs. The second objective function works on keeping the queried services at a SLA-compliant level. Both objectives are addressed simultaneously and formulated in equations (5) and (6):

Minimizing the hosting Cost=Minimizing (Σᵢ^{S} Hosting_Costᵢ) (5)

Where Hosting_Costᵢ is the hosting cost of the service i at a certain time slot, and S is the number of services.

Maximizing the SLA=Maximizing (Σᵢ^{S} Current_SLAᵢ) (6)

Where Current_SLAᵢ is the current SLA value submitted to the potential fails of the addressed service i, and S the number of services.

The scheduling step is always or usually done by respecting the following constraints:
each VM n of a service i can be assigned to one and only one type of machine m,
the machines owned by the web-service company Mₚᵣᵢᵥₐₜₑ are in limited number,
each VM n of a service i is assigned to a machine Mₚᵣᵢᵥₐₜₑ of the private cloud only after verifying its available capacity, otherwise the VM is assigned to public machines M_{public}.

The two objectives in the present approach are addressed in a Pareto way. Besides, there is a third objective to consider: the VM migration reduction which is addressed implicitly. Indeed, in the latter, the VM migration is taken into account during the initialization process of the algorithms. They initialize the solutions of the new workload slot paying attention to keep the reused VMs, as much as possible, assigned to the same machine type as during the previous workload slot scheduling.

The idea behind the proposed prediction technique is to benefit from the features uniqueness that each day of the year may have. Indeed, some days can be similar in behavior, while some others can be really specific. For example, days such as the black Friday, the cyber Monday, holiday period or specific big event like TV shows or games will generate a specific behavior that is different from the previous days but similar to the same period of the years before. Therefore, the prediction model is not based on the proximity history but on the periodicity history. Hence, each day is defined by parameters such as its full date and its status (weekend, special period, holidays, etc.). Its workload prediction is deduced from the history of the days of the years before. Time series techniques are applied to cross-check the data of the days that fit these parameters. This helps providing the workload behavior for the predicted day in a form of a distribution law.

Next, the data is sampled by dividing the day into slots, therefrom the number of requests for each service in each slot is deduced. The number of allocated VMs for each service is computed according to the type (size) of the VM needed by the service and the topology of the service. Hence, since the type (size) of the VM depends mainly on its number of cores and memory capacity, then the more the VM has cores and memory capacity the more requests it can process.

Besides, regarding the topology of the services, the services are classified according to their trend to use the three-tier architecture (front, middle, back). Hence, depending on the type of queries of the service, each tier of the architecture may not be equally used. It is known that usually the more the service is complex, the deeper it goes in architecture. As result, there is a decrease in the processing capacity of the involved VMs as the complexity increases. To set the processing limit of each service, the processing limit of one core of a E5620 Xeon 2.4 GHz 12Mo cache processor can be used.

Moreover, the density of VM needs for each service changes according to the evolution trend of its workload. Indeed, the more a slot is close from the workload peak of a service the highest the requests density is for this service. This means that the chance to have simultaneous queries from end-users is high. Therefore, the computation of the number of VMs evolves according to both the number of predicted requests in the slot and the timing of their arrival compared to the peak. In other words, starting from the mean value and the standard deviation of the workload, one retrieves information about respectively the maximum workload value and the slop angle (variation intensity) of the normal distribution.

Equation 8 shows how to compute the density coefficient which provides information on the evolution trend of service workload, while Equation 9 describes how to compute the number of VMs of each service at each slot depending on both the timing (density coefficient) and the amount of queries.

$$\begin{matrix} {Density\_Coef}_{k , i} = \frac{Max\_Nb {\_request}_{i}}{{Nb\_request}_{k , i}} & ( 8 ) \\ {Number\_VMs}_{k , i} = \frac{{Nb\_request}_{k , i}}{Max\_req {\_Process}_{i} {Nb\_Cores}_{i} {Density\_Coef}_{k , i}} & ( 9 )\end{matrix}$$

Where Density_Coef_{k,i} is the value that represents the density of requests that the service i is expected to deal with during the slot k, Max_Nb_requestᵢ is the maximum number of requests that a service i can receive during the day for a certain slot, Nb_request_{k,i} is the number of requests that the service i is expected to receive during the slot k, Number_VMs_{k,i} is the number of VMs needed for the service i during the slot k, Max_req_Processᵢ is the maximum number of queries that one core of the VM type of the service i can process and finally Nb_Coresᵢ represents the number of cores of the VM type of the service i.

Moreover, for each service, a query threshold value is fixed. The query threshold is the value that represents the number of queries that requires more than the minimum number of standby VMs for each service. Therefore, the prediction of the time duration of each service is defined to be the period between the first slot and the last slot that contains a number of queries greater than the query threshold value.

The genetic algorithm scheduler proposed by some embodiments uses a Pareto optimization. Before detailing the different steps of the algorithm, the Pareto multi-objective problem concepts will be first explained.

A multi-objective optimization problem (MOP) includes or consists generally in optimizing a vector of nb_{obj} objective functions F(x)=(f₁(x), . . . f_{nb}_{_{obj}}(x)), where x is a d-dimensional decision vector x=(x₁, . . . , x_{d}) from some universe called decision space. The space the objective vector belongs to is called the objective space. F can be defined as a cost function from the decision space to the objective space that evaluates the quality of each solution (x₁, . . . , x_{d}) by assigning it an objective vector (y₁, . . . , y_{nb}_{_{obj}}), called the fitness. While single-objective optimization problems have a unique optimal solution, a MOP may have a set of solutions known as the Pareto optimal set. The image of this set in the objective space is denoted as the Pareto front. For minimization problems, the Pareto concepts of MOPs are defined as follows (for maximization problems the definitions are similar).
Pareto dominance: an objective vector y¹ dominates another vector y² if no component of y² is smaller than the corresponding component of y¹, and at least one component of y² is greater than its correspondent in y¹ i.e.:

$$\{ \begin{matrix}∀ i ∈ [ 1 , {nb}_{obj} ] , {y}_{i}^{1} \leq {y}_{i}^{2} \\ ∀ j ∈ [ 1 , {nb}_{obj} ] , {y}_{j}^{1} < {y}_{j}^{2}\end{matrix}$$

Pareto optimality: a solution x of the decision space is Pareto optimal if there is no solution x′ in the decision space for which F(x′) dominates F(x).
Pareto optimal set: for a MOP, the Pareto optimal set is the Pareto optimal solutions.
Pareto front: for a MOP, the Pareto front is the image of the Pareto optimal set in the objective space.

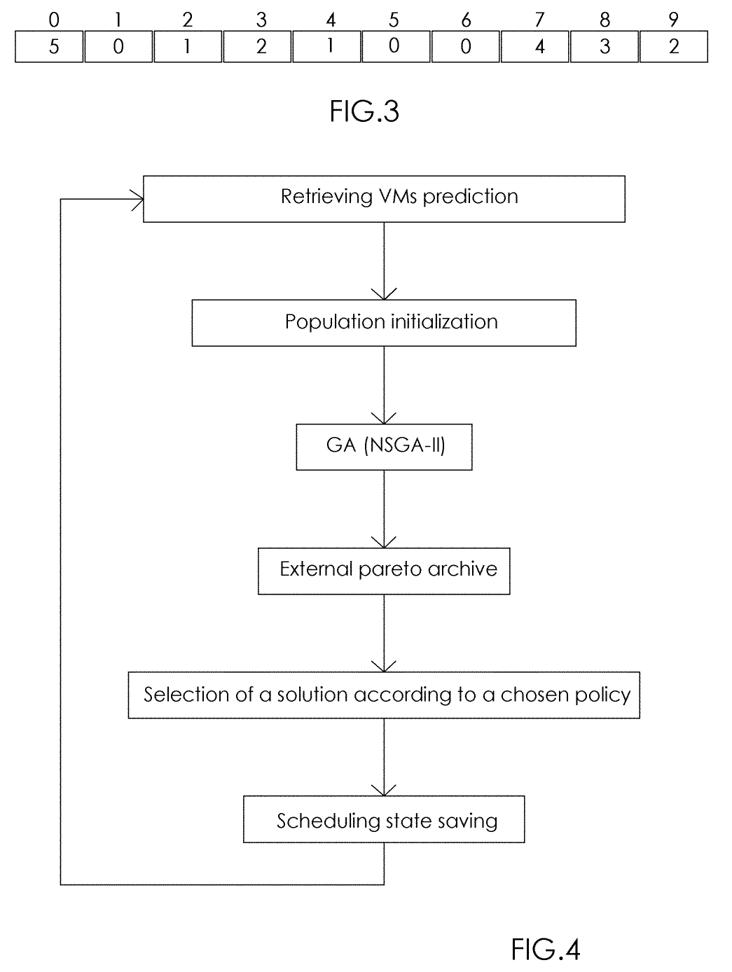

Now we refer to FIG. 3 to illustrate the problem encoding advantageous or preferred choice to formulate the problem. It represents one possible assignment. Thus, the indexes of the table depict the VMs that are scheduled; the number which is contained by each cell of the table identifies the type of machine to which the VM is allocated. In other words, in FIG. 3, the first cell represents the first VM in the current slot that is treated by the scheduling algorithm; it is identified with the index 0 and is assigned to a machine of type 5. The second VM with the index 1 is assigned to a machine of type 0 and so on. This encoding informs about the number of VMs currently addressed (i.e. 10 in the example) and whom services are queried above the query threshold limit. Indeed, it allows one to schedule all the VMs by assigning each one to only one machine type at time. But a machine type can be chosen for more than one VM. Note that not all the machine types are necessarily used in each solution. It is assumed that the public part of the hybrid cloud has always available machines. Moreover, in order to keep a track of the previously assigned VM during the scheduling process of a new slot, it is proposed a meta-information vector for each VM. The objective is to provide a bijection between the VM indexes in the encoded solution and the information of the VM such as (VM identifier, membership service, resource needs . . . ). The lifetime of both the VM meta-information and the solution vectors are tightly related.

One step of the computing scheduling method is the generation of the initial solutions. This step affects the quality of the future results. In the present approach, the initialization of the population follows 2 steps and uses 3 different initialization processes.

The first step is to verify if a VM in the currently scheduled slot is already running from a previous one. Indeed, as previously said, all the developed approaches aim at reducing the migration. Therefore, if the VM is already running, its machine type is retrieved in order to assign it in the new scheduling process to the same machine. The three-objective version of the genetic algorithm is not fitted with the migration-aware step since the migration is integrated as a whole objective.

The second step based on three different initialization processes concerns the new VMs (i.e. first scheduling) or the previously running VMs that do not respect the capacity constraints. The first process initializes the VM randomly to any machine type regardless its location. The second process gives advantage to the low cost private machine types. The third process uses the powerful machine types of the public part of the hybrid cloud. The total initialization of the population alternates between the three processes successively.

Now it is refered to FIG. 4 to expose all the steps of the proposed prediction-based genetic algorithm scheduler (P-GAS). Each scheduling is made on the pool of VMs which is predicted by the history-based resource prediction level previously detailed. Therefore, the results of each cycle of P-GAS concerns the scheduling of one slot of the day. Since each slot has a duration time of fifteen minutes, one needs 96 cycles to obtain the prediction scheduling of the whole day. Each slot scheduling process is called a slot scheduling cycle. The first step of the flowchart drawn in FIG. 4 is to retrieve the predicted pool of VMs from the resource prediction level. Once this phase is done, the information is used to initialize the population of the genetic algorithm.

This population is used by the genetic algorithm as basis to find the best or better assignments possible over the different machine types which compose the hybrid cloud infrastructure. The result of the execution is stored in a Pareto archive.

At the end of the genetic algorithm process, the algorithm chooses one solution (assignment) in the final Pareto archive according to the selection policy.

The chosen solution from the Pareto set is validated and represents the new state of the hybrid cloud. This state will be a basis for a new slot scheduling cycle where the P-GAS approach will make another process on a new pool of predicted VMs. P-GAS keeps iterating and proposes prediction assignments for all the slots until the end of the day.

According to an advantageous or preferred realization of some embodiments, the genetic algorithm (GA) is of type NSGA-II (Non-dominated Sorting Genetic Algorithm-II).

Genetic Algorithms (GAs) are meta-heuristics based on the iterative application of stochastic operators on a population of candidate solutions. In the Pareto-oriented multi-objective context, the structure of the GA remains almost the same as in the mono-objective context. However, some adaptations are required like in the present proposed approach.

The present GA starts by initializing the population as previously indicated. This population is used to generate offspring using specific mutation and crossover operators presented later. Each time a modification is performed by those operators on each individual, an evaluation operator (fitness) is called to evaluate the offspring. The fitness of each scheduling (solution) in the present bi-objective GA is the tradeoff tuple composed of the hosting cost and the SLA value. In the three-objective version of the GA, the tuple integrates in addition the number of migrated VMs.

Because of the multi-objective context, the method used in the proposed GA to rank the individuals of the population is the dominance depth fitness assignment. Hence, only the individuals (solutions) with the best or better rank are stored in the Pareto archive. As an effect, the archive contains all the different non-dominated solutions generated through the generations. Jointly to the ranking each stored solution is assigned with a value called the crowding distance.

Besides, the next step of the GA, the selection process, is based on two major mechanisms: elitism and crowding. Elitism makes the evolution process converge to the best or better Pareto front while crowding maintains some diversity for potential alternative solutions. The role of the selection is to choose the individuals which, thanks to the variation operators, will give birth to the individuals of the next generation (offsprings).

The selection strategy is based on a tournament. Tournament selection includes or consists in randomly selecting k individuals, where k is the size of the tournament group, either from the Pareto archive, the population or both of them. These k individuals will be subject to two additional steps to obtain the individuals to which the variation operators will be applied. The first step selects individuals according to their non-dominance ranking while the second step involves the crowding process by ranking again the individuals according to their crowding distance. The crowding distance is a metric that informs about the similarity degree of each individual compared to the others. The similarity (diversity) in crowding is defined as the circumference of the rectangle defined by the left and the right neighbors of the solution or by its unique side neighbor and the infinity in case of a single neighbor.

When variation operators are applied and new solutions (offspring) are generated, a replacement of the old solutions may be necessary in order to keep constant the number of individuals in the population. The replacement of the old solutions follows an elitist strategy where the worst individuals of the population are replaced by the new ones (offspring). This replacement is based also on the dominance depth fitness metric and when appropriate the crowding distance. The algorithm stops when no improvement on the best or better solutions is performed after a fixed number of generations. Once this number of iteration reached, the final Pareto archive is made available for the next step of the P-GAS approach (selection policy step).

Regarding the principle of the stochastic variation operators of the present genetic algorithm, there is two operators: mutation and crossover. The mutation operator is based on two actions. Indeed, in the first action the operator chooses randomly two integers i and j such that 1≤i<j≤N (N is the solution length) and shifts by one cell to the left all the machine types between the VM i and j. At the end of the switch action each VM in the interval between i and j will be assigned to the machine type of its adjacent cell considering the VM i and j adjacent as well. The second action changes the machine type value for two VMs randomly. Each action has 50% chances to be triggered when the mutation operator is applied.

Furthermore, the crossover operator uses two solutions s₁ and s₂ to generate two new solutions s₁′ and s₂′. The operator picks also two integers on each solution to make the crossover. The full mechanism is explained bellow. These operations are done only if the number of the scheduled VMs is greater than two for the mutation and greater than three for the crossover. Indeed, when no operator can be applied (i.e. only one VM to schedule), the diversity is obtained from the number of the individuals of the population resulting from the initialization.

To generate s₁′ the crossover operator:
considers s₁ as the first parent and s₂ as the second parent.
randomly selects two integers i and j such that 1≤i<j≤N.
copies in s₁′ all values of s₁ located before i or after j. These values are copied according to their positions (s₁′ₙ if n<i or k>j).
copies in a solution s all values of s₂ that are not yet in s₁′. Thus, the new solution s contains (j−i+1) values. The first value is at position 1 and the last value at the position (j−i+1).
and finally, copies all the values of s to the positions of s₁′ located between i and j (s₁′ₙ=sₙ₋ᵢ₊₁ for all i≤k≤j).

The solution s₂′ is generated using the same method by considering s₂ as the first parent and s₁ as the second parent. The values are the machine type values to which the VMs are assigned.

As previously said, the results obtained using a Pareto approach are stored in a Pareto archive. Hence, starting the process of a new pool of VMs for a new prediction slot from several solutions from the Pareto set is not desirable. Therefore, in the present P-GAS there is a selection policy step which comes right after the end of the GA. This step aims to pick up a solution among the final Pareto archive in order to set a state (a starting point) for the hybrid cloud for the next slot scheduling cycle. The idea behind choosing a Pareto approach is proposing to the provider as many compromise solutions as possible. Each one of these solutions is better than the other regarding a specific objective.

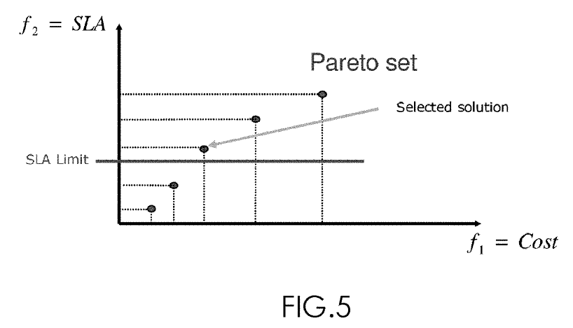

The chosen Pareto selection mechanism is static; it depends on the choice done by the supervisor according to its proper needs. The selection policy is set to select the solution that offers the minimum SLA-compliant value with the lowest hosting cost. In case of dealing with only non-compliant SLA solutions, the selection policy favors the SLA choosing the solution with the highest SLA value regardless the hosting cost criterion. Modifying the SLA compliance threshold allows the supervisor to change the selection policy at its own discretion. FIG. 5 is an example of one possible selection policy.

1. A computing scheduling method for a market-oriented hybrid cloud infrastructure composed of private and public machines and characterized by services specified in a contract, comprising the steps of:
transforming a continuous flow of requests into batches,
predicting a pool of virtual machines (VMs) assigned to several services, for a day, including the operations of:
taking into account the history data of at least one year before the studied day, wherein each day is identified by its date and its status such as business day, weekend, special period or holidays, the history data containing the workload behavior of each service for each day,
retrieving the history data of at least one day of the year(s), characterized by the same information status and calendar date,
retrieving the workload behavior of each service for the day, based on the retrieved history data of the day before the studied day, and defining assignments of a finished number of virtual machines for each service workload, each VM n being defined by a tuple (sizeₙ,nbₙ,fₙ,mₙ,ioₙ,bwₙ,sₙ) wherein sizeₙ is the size of the VM, nbₙ is its number of cores, fₙ is the processor frequency, mₙ is the memory capacity, ioₙ is its input and output capacity, bwₙ is its network bandwidth capacity, sₙ its storage capacity, and each service i being identified by a triplet (rqᵢ,vmᵢ,natureᵢ), wherein rqᵢ is the total number of requests per day, vmᵢ is the type and size of needed VMs, and natureᵢ is the nature of the service,
sampling the service workload by dividing the day into slots of a finished period of time, the duration period of a slot being a parameter,
predicting the number of requests Nb_request_{k,i} for each service i in a slot k, using time series methods over the matching days history,
generating, from the history statistics, a distribution law of each service i for a specific day,
computing the density of requests Density_Coef_{k,i} that each service i is expected to deal with during the slot k applying the formula Density_Coef_{k,i}=Max_Nb_requestᵢ/Nb_request_{k,i} wherein Max_Nb_requestᵢ is the maximum number of requests that a service can receive during the day for a slot, and corresponds to the highest value of the expected distribution law generated from the history statistics of a service i for a specific day,
retrieving from the service workload predictions (Density_Coef_{k,i}, Nb_request_{k,i}), the number of VMs for a slot of the day as follows:
computing the number of needed VMs Number_VMs_{k,i} for each service i at each slot k, applying the formula
$${Number\_VMs}_{k , i} = \frac{{Nb\_request}_{k , i}}{Max\_req {\_Process}_{i} Nb\_Cores {Density\_coef}_{k , i}}$$
wherein Max_req_Processᵢ is the maximum number of requests that one core of the VM type of the service i can process, and Nb_Coresᵢ is the number of cores of the VM type of the service i,
computing the time duration of each service as the period between the first slot and the last slot that contains a number of requests greater than a fixed query threshold value,
initializing, for a slot k, a population of VMs assignments, further comprising including the steps of:
retrieving the machine type of a VM and assigning it in a new scheduling process to the same machine type if the concerned VM in the currently scheduled slot is already running from a previous one,
otherwise initializing the VMs assignment by alternating the three following processes: a random initialization of the VMs to any machine type, initializing all the VMs to the low cost private machine type, initializing all the VMs to the public machine type with the highest performance in terms of computation (CPU) and memory (RAM),
applying a genetic algorithm returning several solutions of assignments of VMs over the different machine types composing the hybrid cloud infrastructure, these solutions being stored in the same format as a table of cells wherein each index of a cell represents the identifier of a VM and the value of a cell is the identification number of a machine type,
storing this set of solutions in a Pareto archive,
choosing one solution from the Pareto archive according to a chosen policy,
saving the chosen solution as the new state of the hybrid cloud,
repeating the steps from the VM prediction retrieving of a slot for the following slots until all the slots of the studied day are processed.

2. The method according to claim 1, wherein the maximum number of requests Max_Nb_requestᵢ for each service i is deducted from the distribution law of both the current processed day and the adequate service, by extracting the maximum number of requests that a service i can receive during the day for a certain slot.

3. The method according to claim 1, wherein the query threshold value is equal to the number of queries that requires more than the minimum number of standby VMs for each service.

4. The method according to claim 1, wherein the duration of a slot is fixed to fifteen minutes.

5. The method according to claim 1, wherein the applied genetic algorithm at each slot cycle is of type NSGA II wherein:
it uses the population provided by the initialization process
it uses both a swap and shift mutation process,
it uses a two-point crossover operation to generate two solutions s′₁ and s′₂ from two parent solutions s₁ and s₂,
it uses a tournament selection strategy comprising the operations of:
randomly selecting two solutions, either from the Pareto archive, the population or both of them,
selecting individuals according to their non-dominance ranking
ranking the individuals according to their crowding distance, the crowding distance being the value of the circumference of the rectangle defined by the left and the right neighbors of the solution or by its unique side neighbor and the infinity in case of a single neighbor
the population size is one hundred,
the number of generations is five hundred,
the crossover rate is one,
the mutation rate is 0.35,
the fitness of each scheduling solution is computed using the hosting cost and the service level agreement (SLA) value (satisfaction level) of the addressed services, wherein:
the SLA value of the addressed services is the sum of all the SLA values of the hosted services, where the SLA value of a service is calculated with the formula Current_SLAᵢ−(Slot_Percent_Valueᵢ Penalty_Checkᵢ) where Slot_Percent_Valueᵢ is the fixed percent value of SLA decrease for each slot time of SLA non-compliance, and Penalty_Checkᵢ computed with the steps of:
initializing its value with the formula Penalty_Checkᵢ=Current_Performanceᵢ−(Performance_Thresholdᵢ(1−Fuzziness_Parameterᵢ)), where Current_Performanceᵢ is the current performance value returned by the sensors, Performance_Thresholdᵢ is the threshold value below which the service is not SLA compliant, Fuzziness_Parameterᵢ is the parameter that defines the flexibility rate of the performance evaluation,
assigning the value zero to Penalty_Checkᵢ if Penalty_Checkᵢ≥0 then Penalty_Checkᵢ=0, one otherwise,
the hosting cost is the sum of all the services' hosting costs, wherein the hosting cost of a service i is calculated with the formula Hosting_Costᵢ=Σ_{N}((VM_Cost_per_hₙ durationᵢ)+Penalty_Costᵢ), where Hosting_Costᵢ is the hosting cost estimation for a service at a given moment in a day, VM_Cost_per_hₙ is the VM cost for one hour operation, durationₛ is the remaining expected service time duration at a given moment in the day, Penalty_Costᵢ is the penalty cost that the provider has to pay in addition to the operating expenditures while hosting the service i and N represents the number of needed VMs to run the service properly, the Penalty_Costᵢ of a service i being computed with the steps of:
retrieving the new current SLA service value Current_SLAᵢ
computing the difference Delta_SLAᵢ between the current SLA value Current_SLAᵢ and the minimum SLA value of the addressed service Minimum_SLAᵢ
assigning zero to Delta_SLAᵢ if Delta_SLAᵢ≥0, and its absolute value otherwise,
finally computing the Penalty_Costᵢ as the product of Delta_SLAᵢ and Unitary_Penaltyᵢ, where Unitary_Penaltyᵢ is the unitary penalty cost for each decrease of the SLA of the service (defined in the Service Level Agreement).

6. Method The method according to claim 1, wherein the assignment of VMs to services is done simultaneously minimizing the sum of hosting costs of the services and maximizing the sum of current service SLA values and according to the following constraints:
each VM of a service i can be assigned to only one type of machine,
there is a limited number of machines in the private cloud,
each VM of a service i is assigned to a private machine only after verifying the available capacity, otherwise the VM is assigned to a public machine.

7. The method according to claim 1, wherein the selection process is done by a user by selecting manually the most appropriate solution in the Pareto archive according to its current needs.

8. The method according to claim 7, wherein the selection policy comprises:
selecting the solution that offers the minimum SLA-compliant value with the lowest hosting cost,
choosing the solution with the highest SLA value regardless the hosting cost criterion, if dealing with only non-compliant SLA solutions.
